(19) United States
(12) Patent Application Publication
(10) Pub. No.: US 2008/0291133 A1
(43) Pub. Date: Nov. 27, 2008

(54) Plasma display, controller therefor, and driving method thereof

(76) Inventors: Hyun-Seok Nam, Suwon-si (KR); Kang-Hee Lee, Suwon-si (KR); Soo-Hyun Kim, Suwon-si (KR); Tae-Kyoung Kang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/081,993

(22) Filed: Apr. 24, 2008

(30) Foreign Application Priority Data
May 23, 2007 (KR) 10-2007-0050436

(51) Int. Cl. G09G 3/28

(52) U.S. Cl. 345/63

(57) ABSTRACT

A plasma display according to an exemplary embodiment of the present invention applies different driving methods according to a maximum grayscale level of image data input for one field. When the maximum grayscale level of the field is higher than a reference level, an address period for selecting a light emitting cell and a non-light emitting cell from a plurality of discharge cells and a sustain period for sustain-discharging light emitting cells among the plurality of discharge cells are simultaneously driven in a plurality of sequential subfields after a first subfield. When the maximum grayscale level of the field is less than the reference level, the address period and the sustain period are time-separately driven in the plurality of subfields.

### BACKGROUND OF THE INVENTION

1. Field of the Invention

Embodiments relate to a plasma display, a controller therefor, and a driving method thereof.

2. Description of the Related Art

A plasma display panel (PDP) is a flat panel display that uses plasma generated by gas discharge to display characters or images. Depending on its size, the PDP may include more than several scores to millions of pixels arranged in a matrix pattern.

In the plasma display, one field (1 TV field) to be driven may be divided into a plurality of subfields respectively having a weight value. Grayscales may be displayed by combining weight values of subfields in which a display operation is generated. During an address period of each subfield, discharge cells that will emit light and discharge cells that will not emit light are selected by an address discharge.

During a sustain period of each subfield, discharge cells to emit light are sustain discharged during a period corresponding to the weight value of a corresponding subfield, thereby displaying an image.

When temporally dividing an address period and a sustain period, an additional address period may be provided to each subfield for addressing all discharge cells in addition to the sustain period for sustain-discharging, thereby increasing the length of a subfield. As a result, a length of a subfield may be increased and a number of subfields that are usable in one field may be limited.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments are therefore directed to a plasma display, a controller therefor, and a driving method thereof, which overcome one or more of the problems due to the limitations and disadvantages of the related art.

It is therefore a feature of an embodiment to provide a plasma display for expressing a high grayscale level, a controller therefor, and a driving method thereof.

It is therefore another feature of an embodiment to provide a plasma display providing improved expression of lower grayscale levels, a controller therefor, and a driving method thereof.

At least one of the above and other features and advantages may be realized by providing a driving method of a plasma display including a plurality of row electrodes, a plurality of column electrodes, and a plurality of discharge cells respectively defined by the plurality of row electrode and the plurality of column electrodes, the driving method for driving the plasma display including dividing one field into a plurality of subfields, the driving method including determining a maximum grayscale level of a video signal input for one field, comparing the maximum grayscale level of the video signal to a reference level, and driving the plasma display in accordance with the comparing. When the maximum grayscale level of the video signal is greater than the reference level, driving a plurality of subsequent subfields after a first subfield may include dividing the plurality of row electrodes into first and second row electrode groups, and sustain discharging light emitting cells in a second subgroup of the second row electrode group while selecting a non-light emitting cells from a plurality of light emitting cells in a first subgroup of the first row electrode group. When the maximum grayscale level of the video signal is less than the reference level, driving the plurality of subfields may include selecting the light emitting cell from the plurality of discharge cells, and sustain-discharging the selected light emitting cell.

When the maximum grayscale level of the video signal is greater than the reference level, the method may include sustain discharging light emitting cells in a subgroup of the first row electrode group while selecting non-light emitting cells from the light emitting cells in a subgroup of second row electrode group.

When the maximum grayscale level of the video signal is less than the reference level, the method may include establishing the plurality of discharge cells as non-light emitting cells before selecting light emitting cells.

When the maximum grayscale level of the video signal is greater than the reference level, in a first subfield before the plurality of subsequent subfields, the method may include selecting light emitting cells from discharge cells in the first row electrode group, and sustain-discharging the selected light emitting cell of the first row electrode group, and selecting light emitting cells from the discharge cells in the second row electrode group, and sustain-discharging the selected light emitting cells of the second row electrode group. The method may include, in the first subfield, establishing the plurality of discharge cells as the non-light emitting cells before selecting the light emitting cell from the discharge cells included in the first row electrode group.

A number of subfields that may be realized when using the driving corresponding to when the maximum grayscale level of the video signal may be greater than the reference level is larger than a number of subfields that may be realized when using the driving corresponding to when the maximum grayscale level of the video signal is less than the reference level.

The may be about ⅔ of a maximum grayscale level that may be expressed when using the driving corresponding to when the maximum grayscale level of the video signal is greater than a reference level.

When the maximum grayscale level of the video signal is greater than the reference level, and a desired grayscale level may not be expressed from a combination of subfields, dithering subfields having levels closest to the desired grayscale level.

At least one of the above and other features and advantages may be realized by providing a plasma display, including a plasma display panel (PDP) including a plurality of row electrodes, a plurality of column electrodes crossing the plurality of row electrodes, a plurality of discharge cells defined by the plurality of row electrodes and the plurality of column electrodes, a driver configured to drive the PDP, and a controller configured to determine a maximum grayscale level from a video signal input for one field, to compare the maximum grayscale level of the video signal to a reference level, and to control the driver in accordance with the comparison. When the maximum grayscale level of the video signal is greater than the reference level, for a plurality of subsequent subfields after a first subfield, the driver may be configured to select one of light emitting cells and non-light emitting cells from the plurality of discharge cells, and simultaneously sustain discharge cells among previous light emitting cells. When the maximum grayscale level of the video signal is less than the reference level, the driver may be configured to select light emitting cells from the plurality of discharge cells, and sustain discharge the selected light emitting cells.

When the maximum grayscale level of the video signal is greater than the reference level, the driver may be configured to select light emitting cells in the first subfield and non-light emitting cells in the plurality of subsequent subfields. The driver may be configured to establish the plurality of discharge cells as non-light emitting cells before selecting light emitting cells in a subsequent field.

When the maximum grayscale level of the video signal is greater than the reference level, the driver may be configured, for the plurality of subsequent subfields, to divide the plurality of row electrodes into first and second row electrode groups, divide the first and second row electrode groups into a plurality of first and second subgroups, sustain discharge light emitting cells of a subgroup among the plurality of second subgroups and simultaneously select non-light emitting cells from light emitting cells of a subgroup among the plurality of first subgroups, and sustain discharge light emitting cells of a first subgroup among the plurality of first subgroups and simultaneously select non-light emitting cells from light emitting cells of a subgroup of the second subgroups.

When the maximum grayscale level of the video signal is greater than the reference level, the driver may be configured, for at least one subfield before the plurality of subsequent subfields, to select light emitting cells from the discharge cells of the first row electrode group and sustain discharge the selected light emitting cells of the first row electrode group, and select light emitting cells from the discharge cells of the second row electrode group, and sustain discharge the selected light emitting cell of the second row electrode group.

At least one of the above and other features and advantages may be realized by providing a plasma display, including a plasma display panel (PDP) including a plurality of row electrodes, a plurality of column electrodes crossing the plurality of row electrodes, and a plurality of discharge cells defined by the plurality of row electrodes and the plurality of column electrodes, a driver configured to drive the PDP, and a controller configured to determine a maximum grayscale level from a video signal input for one field, to compare the maximum grayscale level from the video signal with a reference level, and to control the driver according to a result of the comparison. When the maximum grayscale level greater than the reference level, the driver is configured, in a first subfield, to divide the plurality of row electrodes into first and second row electrode groups, divide the first and second row electrode groups into a plurality of first and second subgroups, sequentially address discharge row electrodes in a first subgroup using a first address discharge method to establish light emitting cells in the first subgroup during a first period for respective first subgroups, sustain discharge previously established light emitting cells in second subgroups during a plurality of first periods, sequentially address discharge row electrodes in a second subgroup using the first address discharge method to establish light emitting cells in the second subgroup during a second period for respective second subgroups, and sustain discharge previously established light emitting cells in first subgroups during a plurality of second periods. When the maximum grayscale level less than the reference level, the driver is configured, in each of the plurality of subfields, to sequentially address discharge the plurality of row electrodes using a second address discharge method to establish light emitting cells during a third period, and sustain discharge the established light emitting cells during a fourth period.

Discharge cells in a light emitting state may be established to be in a non-light emitting state by the first address discharge method, and discharge cells in a non-light emitting state may be established to be in the light emitting discharge state by the second address discharge method.

The driver may be configured to establish the plurality of discharge cells as light emitting cells immediately before the earliest first period among the plurality of first periods when using the first address discharge method, and to establish the plurality of discharge cells as non-light emitting cells in the plurality of respective subfields before selecting the light emitting cell when using the second address discharge method.

The respective row electrodes may be defined by first and second electrodes, and the driver is configured to, during the first period for the respective first subgroups, sequentially apply a scan pulse of a first level to the plurality of first electrodes included in the corresponding subgroup and apply an address pulse to the column electrode forming the non-light emitting cell among the light emitting cells defined by the first electrode included in the first subgroup to which the scan pulse is applied, and during the third period, sequentially apply the scan pulse of a second level to the plurality of first electrodes, and apply the address pulse to the column electrode forming the light emitting cell among the non-light emitting cells defined by the plurality of first electrodes to which the scan pulse of the second level is applied.

The respective row electrodes may be defined by first and second electrodes, and the driver may be configured to apply first and second sustain pulses having inverse phases to the first and second electrodes included in at least one second subgroup among the plurality of second subgroups during the first period for the respective first subgroups, and respectively apply the first and second sustain pulses to the plurality of first electrodes and the plurality of second electrodes during the fourth period, and the first and second sustain pulses respectively have a high level voltage and a low level voltage.

One second period among the plurality of second periods may be positioned between the respective first periods among the plurality of first periods.

At least one of the above and other features and advantages may be realized by providing a controller configured to control a driver configured to drive a plasma display panel (PDP) including a plurality of row electrodes, a plurality of column electrodes crossing the plurality of row electrodes, a plurality of discharge cells defined by the plurality of row electrodes and the plurality of column electrodes, the controller being configured to determine a maximum grayscale level of a video signal input for one field, compare the maximum grayscale level of the video signal to a reference level, and control the driver of the PDP in accordance with the comparing. When the maximum grayscale level of the video signal is greater than the reference level, for a plurality of subsequent subfields after a first subfield, the driver is configured to divide the plurality of row electrodes into first and second row electrode groups, and sustain discharge light emitting cells in a subgroup of the second row electrode group and simultaneously address discharge row electrodes in a subgroup of the first row electrode group to establish light emitting cells. When the maximum grayscale level of the video signal is less than the reference level, for the plurality of subfields, the driver is configured to select light emitting cells from the plurality of discharge cells, and sustain discharge the selected light emitting cells.

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 illustrates a plasma display according to an exemplary embodiment of the present invention;

FIG. 2 illustrates grouping of electrodes respectively applied to a driving method of a plasma display according to a first exemplary embodiment of the present invention;

FIG. 3 illustrates a driving method of the plasma display according to a first exemplary embodiment of the present invention;

FIG. 4 illustrates the driving method of FIG. 3 applied to subfields;

FIG. 5A illustrates a driving waveform of the first subfield SF1 of FIG. 3;

FIG. 5B illustrates a driving waveform of the k-th subfield (SFk) for use with the second subfield SF2 to the L-th subfield SFL of FIG. 3;

FIG. 6 illustrates a grayscale expression method according to the driving method of FIG. 3;

FIG. 7 illustrates a flowchart of a controller according to the exemplary embodiment of the present invention;

FIG. 8 illustrates a method for driving a plasma display by diving an address period and a sustain period in a temporal manner according to another exemplary embodiment of the present invention;

FIG. 9 illustrates a driving waveform of a plasma display to which the driving method of FIG. 8 is applied; and

FIG. 10 illustrates a grayscale expression method according to the driving method of FIG. 8 driving method.

### DETAILED DESCRIPTION OF THE INVENTION

Korean Patent Application No. 10-2007-0050436, filed on May 23, 2007, in the Korean Intellectual Property Office, and entitled: “Plasma Display and Driving Method Thereof,” is incorporated by reference herein in its entirety.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. In addition, unless explicitly described to the contrary, the word “comprise” and variations such as “comprises” or “comprising” will be understood to imply the inclusion of stated elements but not the exclusion of any other elements.

Wall charges mentioned in the following description mean charges formed and accumulated on a wall (e.g., a dielectric layer) close to an electrode of a discharge cell. A wall charge will be described as being “formed” or “accumulated” on the electrodes, although the wall charges do not actually touch the electrodes. Further, a wall voltage means a potential difference formed on the wall of the discharge cell by the wall charge.

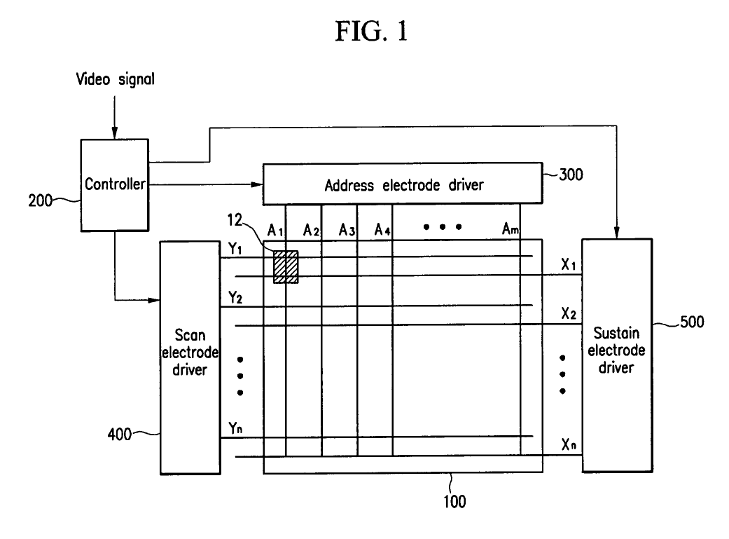

A plasma display according to an exemplary embodiment of the present invention will now be described in further detail with reference to FIG. 1.

FIG. 1 illustrates a plasma display according to an exemplary embodiment of the present invention.

As shown in FIG. 1, the plasma display according to the exemplary embodiment of the present invention may include a plasma display panel (PDP) 100, a controller 200, an address electrode driver 300, a scan electrode driver 400, and a sustain electrode driver 500.

The PDP 100 may include a plurality of address electrodes A₁ to Aₘ extending in a column direction, and a plurality of sustain electrodes X₁ to Xₙ and a plurality of scan electrodes Y₁ to Yₙ extending in a row direction as pairs. Hereinafter, the address electrode, the sustain electrode, and the scan electrode will be respectively referred to as an A electrode, an X electrode, and a Y electrode. Generally, the X electrodes X₁ to Xₙ may correspond to the Y electrodes Y₁ to Yₙ, and the X electrodes X₁ to Xₙ and the Y electrodes Y₁ to Yₙ perform a display operation in order to display an image during a sustain period. The Y electrodes Y₁ to Yₙ and the X electrodes X₁ to Xₙ may perpendicularly cross each other. A discharge space formed at a crossing region of the A electrodes A₁ to Aₘ with the X and Y electrodes X₁ to Xₙ and Y₁ to Yₙ forms a discharge cell 12. This structure of the PDP 100 is merely exemplary, and panels of other structures may be used in the embodiments as well. Hereinafter, an X electrode and an Y electrode extending in a row direction as a pair will be called row electrodes, and an A electrode extending in a column direction will be called a column electrode.

The controller 200 may externally receive video signals, and may output an A electrode driving control signal, an X electrode control signal, and a Y electrode control signal. In addition, the controller 200 may control the plasma display by dividing a frame into a plurality of subfields, and a plurality of row electrodes into a first group and a second group. The controller 200 may then control the row electrodes of the first and second groups by dividing them respectively into a plurality of sub-groups.

The address electrode driver 300 may receive the A electrode driving control signal from the controller 200, and may apply a display data signal to the A electrodes A₁ to Aₘ. The scan electrode driver 400 may receive the Y electrode driving control signal from the controller 200, and may apply a driving voltage to the Y electrodes Y₁ to Yₙ. The sustain electrode driver 500 may receive the X electrode driving control signal from the controller 200, and may apply a driving voltage to the X electrode X₁ to Xₙ.

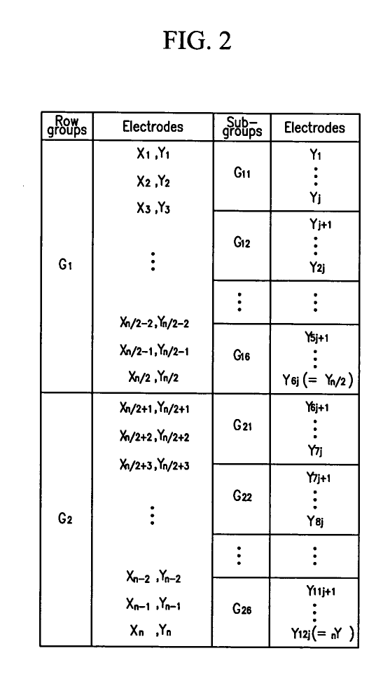

A method for driving the plasma display according to the exemplary embodiment of the present invention will now be described with reference to FIG. 2.

FIG. 2 illustrates grouping of electrodes applied to the driving method of the plasma display according to the exemplary embodiment of the present invention.

As shown in FIG. 2, in one field, a plurality of row electrodes X₁ to Xₙ and Y₁ to Yₙ are divided into two row groups G₁ and G₂. A plurality of row electrodes X₁ to X_{n/2} and Y₁ to Y_{n/2} positioned in a top portion of the PDP 100 may be grouped into a first row group G₁ and a plurality of row electrodes X₁ to X_{n/2} and Y₁ to Y_{n/2} positioned in a bottom portion of the PDP 100 may be grouped into a second group G₂. Alternatively, even-numbered row electrodes may be grouped into a first row group G₁ and odd-numbered row electrodes may be grouped into a second row group G₂. In addition, Y electrodes in the respective first and second row groups G₁ and G₂ may be divided into a plurality of sub-groups G₁₁ to G₁₆ and G₂₁ to G₂₆. For example, as illustrated in FIG. 2, the first and second row groups G₁ and G₂ may be respectively divided into six sub-groups G₁₁ to G₁₆ and G₂₁ to G₂₆.

In particular, in the first row group G₁, the first Y electrode Y₁ to the j-th Y electrodes Yⱼ may be grouped into the first sub-group G₁₁ and the (j+1)-th Y electrode Y(j+1) to the 2j-th Y electrode Y₂ⱼ may be grouped into the second sub-group G₁₂, and so forth. Thus, the (5j+1)-th Y electrode Y₅ⱼ₊₁ to the (n/2)-th Y electrode Y_{n/2} may be grouped into the sixth sub-group G₁₆ (where j is an integer between 1 and n/16). Similarly, in the second row group G₂, the (6j+1)-th Y electrode Y₆ⱼ₊₁ to the 7j-th Y electrode Y₇ⱼ may be grouped into the first sub-group G₂₁, and the (7j+1)-th Y electrode Y₇ⱼ₊₁ to the 8j-th Y electrode Y₈ⱼ may be grouped into the second sub-group G₂₂, as so forth. Thus, the (11j+1)-th Y electrode Y₁₁ⱼ₊₁ to the n-th Y electrode Yₙ may be grouped into the sixth sub-group G₂₆. Alternative sub-groupings may be employed, e.g., Y electrodes having a constant distance from each other in the first and second row groups G₁ and G₂ may be grouped into one sub-group or Y electrodes may be grouped according to an irregular method.

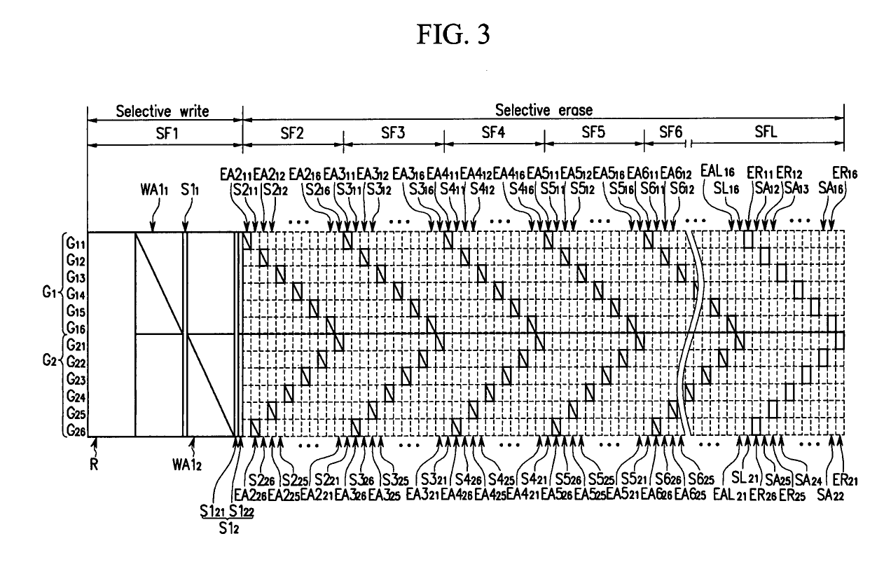

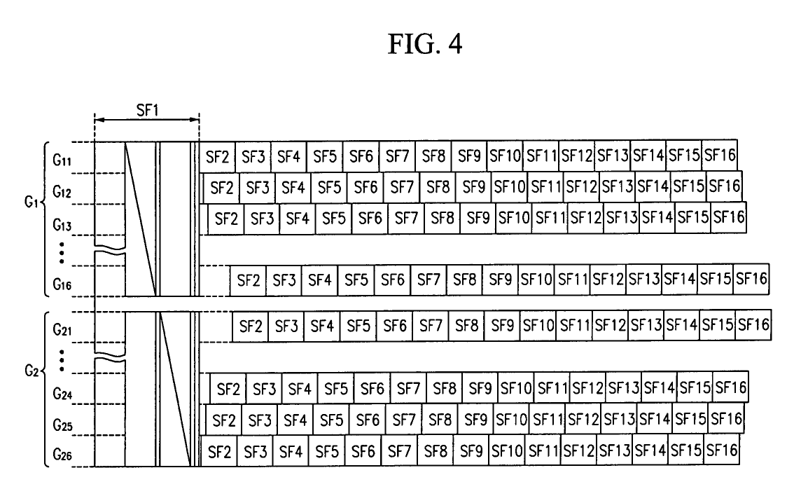

FIG. 3 illustrates a driving method of the plasma display according to the exemplary embodiment of the present invention, and FIG. 4 illustrates the driving method of FIG. 3 applied to subfields. In FIG. 3, the first and second row groups G₁ and G₂ are respectively divided into six sub-groups G₁₁ to G₁₆ and G₂₁ to G₂₆.

As shown in FIG. 3, one field may be divided into a plurality of subfields SF1 to SFL. The first subfield SF1 may include a reset period R, address periods WA1₁ and WA1₂, and sustain periods S1₁ and S1₂. A selective write method may be applied to the address periods WA1₁ and WA1₂. The second to L-th subfields SF2 to SFL may respectively include address periods EA2₁₁ to EAL₁₆ and EA2₂₁ to EAL₂₆, and sustain periods S2₁₁ to SL₁₆ and S2₂₁ to SL₂₆. A selective erase address method may be applied to the address periods EA2₁₁ to EAL₁₆ and EA2₂₁ to EAL₂₆ of the second to L-th subfields SF2 to SFL. In addition, a plurality of row electrodes X₁ to Xₙ and Y₁ to Yₙ may be respectively grouped into first and second row groups G₁ and G₂, and the first and second row groups G₁ and G₂ may be respectively grouped into plurality of sub-groups G₁₁ to G₁₆ and G₂₁ to G₂₆.

Methods for selecting discharge cells to emit light (hereinafter referred to as light emitting cells) and discharge cells to emit no light (hereinafter referred to as non-light-emitting cells) from among a plurality of discharge cells include a selective write method and a selective erase method. The selective write method selects a light emitting cell and generates a constant wall voltage. In other words, in the selective write method, cells in the non-light-emitting state are address discharged and thus, wall charges are formed such that the non-light-emitting state is switched to the light emitting state. The selective erase method selects a non-light-emitting cell and erases the wall voltage. In other words, in the selective erase method, cells in the light emitting state are address discharged and thus, wall charges that had already been formed are erased such that the light emitting state is switched to the non-light-emitting state according to the selective erase method. The address discharge that forms the wall charge in the selective write method is called a “write discharge”, and the address discharge that erases the wall charge in the selective erase method is called an “erase discharge”.

Referring to FIG. 3, in the first subfield SF1 having the address periods WA1₁ and WA1₂ employing the selective write method, the reset period R may be provided before the address periods WA1₁ and WA1₂ so as to initialize all discharge cells in the light emitting state to the non-light emitting state. That is, discharge cells of the first and second row groups G₁ and G₂ are initialized to the non-light emitting state in the reset period R of the first subfield SF1, and are write discharged in the address periods WA1₁ and WA1₂.

Discharge cells set to be light emitting cells among the discharge cells of the first row group G₁ are write-discharged to form wall charges in the address period WA1₁, and discharge cells of the first row groups G₁ are sustain discharged in the sustain period S1₁. In this case, a minimum number (e.g., one or two) of sustain discharges is set to be generated in the sustain period S1₁. Discharge cells set to be light emitting cells among discharge cells of the second row group G₂ are write-discharged to form wall charges in the address period WA1₂, and the discharge cells of the first and second row groups G₁ and G₂ are sustain discharged in a partial period S1₂₁ of the sustain period S1₂. In addition, only the discharge cells of the second row group G₂ are sustain discharged while the discharge cells of the first row group G₁ are not sustain discharged during the other partial period S1₂₂ of the sustain period S1₂. In this case, the number of sustain discharges generated in the discharge cells of the second row group G₂ during the partial period S1₂₂ of the sustain period S1₂ is set to correspond to the number of sustain discharges generated in the discharge cells of the first row group G₁.

When a weight of the first subfield SF1 is not satisfied by the sustain periods S1₁ and S1₂, discharge cells of the first and second row groups G₁ and G₂ may be additionally sustain discharged during the partial period S1₂₂ of the sustain period S1₂.

In the second subfield SF2, the address periods EA2₁₁ to EA2₁₆ may be sequentially applied from the first sub-group G₁₁ to the eighth sub-group G₁₂ of the first row group G₁, and the address periods EA2₂₆ to EA2₂₁ may be sequentially applied from the sixth sub-group G2₂₆ to the first sub-group G₂₁ of the second row group G₂. The address periods EA3₁₁ to EAL₁₆ and EA3₂₁ to EAL₂₆ and the sustain periods S3₁₁ to SL₁₆ and S3₂₁ to SL₂₆ may be sequentially performed from the third subfield to the L-th subfield as in the second subfield. Since address and sustain operations during the address periods EA2₁₁ to EAL₁₆ and EA2₂₁ to EAL₂₆ and the sustain periods S2₁₁ to SL₁₆ and S2₂₁ to SL₂₆ are substantially the same in the subfields SF2 to SFL, only address operations of address periods EAk₁₁ to EAk₁₆ and EAk₂₁ to EAk₂₆ and sustain operations of sustain periods Sk₁₁ to Sk₁₆ and Sk₂₁ to Sk₂₆ of the k-th subfield SFk (where k is an integer between 2 and L) will be described hereinafter.

In particular, in the k-th subfield SFk of the first row group G₁, the sustain period Sk₁ᵢ of the i-th sub-group G₁ᵢ may be performed after the address period EAk₁ᵢ of the i-th sub-group G₁ᵢ is performed (where i is an integer between 1 and 6). Subsequently, the address period EAk₁₍ᵢ₊₁₎ and the sustain period Sk₁₍ᵢ₊₁₎ of the (i+1)-th sub-group G₁₍ᵢ₊₁₎ may be performed. In the k-th subfield SFk of the second row group G₂, the sustain period Sk₂₍ᵢ₊₁₎ of the (i+1) sub-group G₂₍ᵢ₊₁₎ may be performed after the address period EAk₂₍ᵢ₊₁₎ of the (i+1) sub-group G₂₍ᵢ₊₁₎ is performed. Subsequently, the address period EAk₂ᵢ and the sustain period Sk₂ᵢ of the i-th sub-group G₂ᵢ are performed. In this case, in the k-th subfield SFk, the address period EAk₂₍₆₋₍ᵢ₋₁₎₎ of the (6−(i−1))-th sub-group G₂₍₆₋₍ᵢ₋₁₎₎ of the second row group G₂ may be performed while the sustain period Sk₁ᵢ of the i-th sub-group G₁ᵢ of the first row group G₁ is performed. In addition, in the k-th subfield SFk, the address period EAk₁₍ᵢ₊₁₎ of the (i+1)-th sub-group G₁₍ᵢ₊₁₎ may be performed in the first row group G₁ while the sustain period Sk₂₍₆₋₍ᵢ₋₁₎₎ of the second row group G₂ is performed.

Although FIG. 3 illustrates that the address periods EAk₂₆ to EAk₂₁ and the sustain periods Sk₂₆ to Sk₂₁ are sequentially applied from the sixth sub-group G₂₆ to the first sub-group G₂₁ of the second row group G₂, the address periods EAk₂₆ to EAk₂₁ and the sustain periods Sk₂₆ to Sk₂₁ may be sequentially applied from the first sub-group G₂₁ to the sixth sub-group G₂₆, as in the first row group G₁. Alternatively, the address periods and the sustain periods may be applied in a different order in the first and second row groups G₁ and G₂.

The respective subfields SF2 to SFL of the first row group G₁ will now be described in further detail. Discharge cells to be set as non-light emitting cells among discharge cells of the first sub-group G₁₁ of the k-th subfield SFk in the first row group G₁ may be erase-discharged during the address period EAk₁₁ of the first sub-group G₁₁ so as to erase the wall charges, and other discharge cells of the first sub-group G₁₁ may be sustain discharged during the sustain period Sk₁₁. Discharge cells to be set as non-light emitting cells among discharge cells of the second sub-group G₁₂ may be erase-discharged so as to erase the wall charges during the address period EAk₁₂ of the second sub-group G₁₂, and other discharge cells of the second sub-group G₁₂ may be sustain discharged during the sustain period Sk₁₂. At this time, the light emitting cells of the first sub-group G₁₁ may be sustain discharged. The address periods EAk₁₃ to EAk₁₆ and the sustain periods Sk₁₃ to Sk₁₆ may be respectively applied to other sub-groups G₁₃ to G₁₆ as in the manner described above.

In this case, the light emitting cells of the i-th sub-group G₁ᵢ, the first to (i−1)-th sub-groups G₁₁ to G₁₍ᵢ₋₁₎, and the (i+1)-th to sixth sub-groups G₁₍ᵢ₊₁₎ to G₁₆ may be sustain discharged during the sustain period Sk₁ᵢ of the i-th sub-group G₁ᵢ. Herein, the light emitting cells of the first to (i−1)-th sub-groups G₁₁ to G₁₍ᵢ₋₁₎ correspond to the discharge cells that have not experienced an erase discharge during the respective address periods EAk₁₁-EAk₁₍ᵢ₋₁₎ of the k-th subfield SFk, and the light emitting cells of the (i+1)-th to sixth sub-groups G₁₍ᵢ₊₁₎ to G₁₆ correspond to the light emitting cells that have not experienced the erase discharge during the respective address periods EA(k−1)₁₍ᵢ₊₁₎ to EA(k−1)₁₆ of the (k−1)-th subfield SF(k−1). The light emitting cells of the i-th sub-group G₁ᵢ may be sustain discharged until the address period EA(k+1)₁ᵢ of the i-th sub-group G₁ᵢ of the (k+1)-th subfield SF(k+1). That is, the light emitting cells of the i-th sub-group G₁ᵢ may be sustain discharged during six sustain periods.

Accordingly, the address periods EA2₁₁ to EA2₁₆, . . . , EAL₁₁ to EAL₁₆ and the sustain periods S2₁₁ to S2₁₆, . . . , SL₁₁ to SL₁₆ may be applied to the respective sub-groups G₁₁ to G₁₆ of the respective subfields SF2 to SFL. In this way, the discharge cells set to be in a light emitting state during the sustain periods S1₁₁ to S1₁₆ of the first subfield SF1 may be sustain discharged until the discharge cells are erase-discharged in the respective subfields SF2 to SFL and thus, the discharge cells in the light emitting state are switched to the non-light emitting state. After the discharge cells in the light emitting state are switched to the non-light emitting state due to the erase-discharge, no sustain discharge is generated from the corresponding subfield. In this case, a weight of each of the subfields SF2 to SFL corresponds to a sum of the lengths of sixth sustain periods of the respective subfields.

When the sustain period SL₁₆ of the subfield SFL is performed, the first sub-group G₁₁ experiences six sustain discharges, the second sub-group G₁₂ experiences five sustain discharges, and the third sub-group G₁₃ experiences four sustain discharges. In addition, the fourth sub-group G₁₄ experiences three sustain discharges, the fifth sub-group G₁₅ experiences two sustain discharges, and the sixth sub-group G₁₆ experiences one sustain discharge. Accordingly, the first to sixth sub-groups G₁₁ to G₁₆ may experience the same number of sustain discharges. For this purpose, the last subfield SFL of the first row group G₁ may include erase periods ER₁₁ to ER₁₅ and additional sustain periods SA₁₂ to SA₁₆.

Since the first sub-group G₁₁ has been sustain discharged six times immediately before a subsequent erase period ER₁₁, the first sub-group G₁₁ may not need to experience an additional sustain discharge. Therefore, wall charges formed in the light emitting cells of the first sub-group G₁₁ may be erased during the erase period ER₁₁. Then, the light emitting cells of the second to sixth sub-groups G₁₂-G₁₆ may emit light during the additional sustain period SA₁₂. Since the wall charges formed in the light emitting cells of the first sub-group G₁₁ are erased during the erase period ER₁₁, the additional sustain discharge is generated once in the light emitting cells of the second to sixth sub-groups G₁₂ to G₁₆ during the additional sustain period SA₁₂.

Since the second sub-group G₁₂ has been sustain discharged six times due to the additional sustain period SA₁₂, the second sub-group G₁₂ may not need to experience an additional sustain discharge. Therefore, wall charges formed in the light emitting cells of the second sub-group G₁₂ may be erased during the erase period ER₁₂. Then, the light emitting cells of the third to sixth sub-groups G₁₃-G₁₆ may emit light during the addition sustain period SA₁₃. In this case, since the wall charges formed in the light emitting cells of the first and second sub-groups G₁₁ and G₁₂ are erased during the respective erase periods ER₁₁ and ER₁₂, the additional sustain discharge is performed once in the light emitting cells of the third to sixth sub-groups G₁₃-G₁₆ during the additional sustain period SA₁₃.

Subsequently, wall charges formed in the light emitting cells of the third sub-group G₁₃ may be erased during the erase period ER₁₃, since the third sub-group G₁₃ has been sustain discharged six times due to the additional sustain period SA₁₃ and does not need to experience an additional sustain discharge. Then, the light emitting cells of the fourth to sixth sub-groups G₁₄-G₁₆ may emit light during the additional sustain period SA₁₄. In this case, since the wall charges formed in the light emitting cells of the first to third sub-groups G₁₁-G₁₃ are erased during the respective erase periods ER₁₁-ER₁₃, the additional sustain discharge is generated once in the light emitting cells of the fourth to sixth sub-groups G₁₄-G₁₆ respectively during the additional sustain period SA₁₄.

Accordingly, the same number of sustain discharge may be respectively generated in the first to sixth sub-groups G₁₁-G₁₆ by performing the erase periods ER₁₄ to ER₁₅ and the additional sustain periods SA₁₅ to SA₁₆.

An erase period ER₁₆ may be additionally performed for erasing wall charges formed in the sixth sub-group G₁₁ after the additional sustain period SA₁₆ of the sixth sub-group G₁₆. However, the erase period ER₁₆ may not be performed, since the reset period R is applied in the first subfield SF1 of the next field. The erase operation of the respective erase periods ER₁₁ to ER₁₆ may be sequentially performed for each row electrode of the respective sub-groups, or may be simultaneously performed for all row electrodes of the respective row groups.

Respective subfields SF2 to SFL of the second row group G₂ may be the same as those of the first row group G₁ in structure. However, address periods EA2₂₆ to EA2₂₁, . . . , EAL₂₆ to EAL₂₁ may be sequentially applied from the sixth sub-group G₂₆ to the first sub-group G₂₁ in the respective subfields SF1 to SFL of the second row group G₂, and erase periods ER₂₆ to ER₂₅ may be applied from the sixth sub-group G₂₆ to the first sub-group G₂₁ in the last subfield SFL of the second row group G₂.

A driving method of such a plasma display may be described with reference only to subfields as shown in FIG.4. That is, each of the sub-groups G₁₁-G₁₆ and G₂₆-G₂₁ may have a plurality of subfields SF2 to SF16, shifted by a predetermined time from each other. As illustrated in FIG. 4, one field may be divided into 16 subfields SF1 to SF16. In this case, the predetermined time may correspond to a sum of an address period EAk₁ᵢ or EAk₂ᵢ of one sub-group G₁ᵢ or G₂ᵢ and a sustain period Sk₁ᵢ or Sk₂ᵢ of one sub-group G₁ᵢ or G₂ᵢ. If the length of the address period EAk₁ᵢ or EAk₂ᵢ of the sub-group G₁ᵢ or G₂ᵢ corresponds to the length of the sustain period Sk₁ᵢ or Sk₂ᵢ of the sub-group G₁ᵢ or G₂ᵢ, a start point of the respective subfields SF2 to SF16 of the second row group G₂ is shifted by a time between a start point of the respective subfields SF2 to SF16 of the first row group G₁ and the address period EAk₁ᵢ or EAk₂ᵢ.

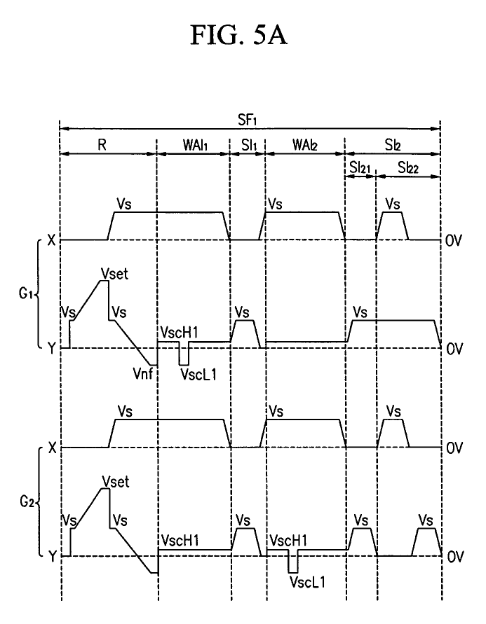

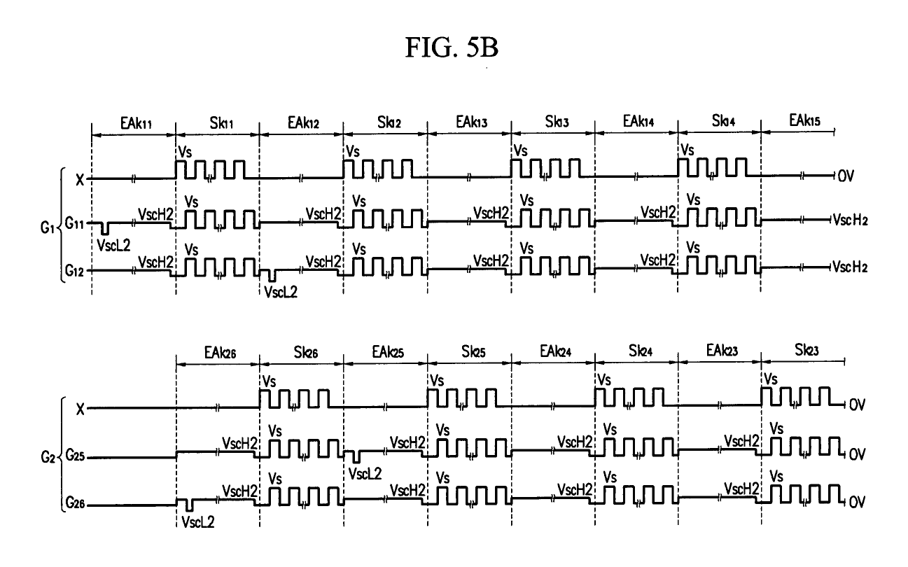

A driving waveform of the plasma display using the driving method of FIG. 3 will now be described in further detail with reference to FIG. 5A and FIG. 5B.

FIG. 5A illustrates a driving waveform of the first subfield SF1 of FIG. 3 in accordance with an embodiment.

As shown in FIG. 5A, during a reset period R, a voltage of the plurality of Y electrodes of the first and second row groups G₁ and G₂ may be gradually increased from a voltage Vs to a voltage Vset and a reference voltage (0V voltage in FIG. 5A) may be applied to the plurality of X electrodes of the first and second row groups G₁ and G₂. A weak reset discharge may be generated between the Y electrodes and the X electrodes while the voltage of the Y electrodes increases, so that wall charges are formed in the discharge cells of the first and second row groups G₁ and G₂. Subsequently, the voltage of the plurality of Y electrodes of the first and second row groups G₁ and G₂ may be gradually decreased from the voltage Vs to a voltage Vnf and the voltage Vs may be applied to the plurality of X electrodes of the first and second row groups G₁ and G₂. A weak reset discharge may be generated between the Y electrodes and the X electrodes while the voltage of the Y electrodes decreases, so that the wall charges formed in the discharge cells of the first and second row groups G₁ and G₂ are erased and the discharge cells are initialized to a non-light emitting state. In general, a voltage (Vnf−Vs) may be set close to a discharge firing voltage between the Y electrode and the X electrode. Thus, since a wall voltage between the Y electrode and the X electrode may approach the reference voltage, a misfire may be prevented during a sustain period in a cell in which no write discharge is generated during the address period.

During the address period WA1₁, a scan pulse having a voltage VscL1 may be sequentially applied to the plurality of Y electrodes of the first group G₁, an address pulse having a positive voltage may be applied to an A electrode for selecting light emitting cells, and the voltage Vs may be applied to the plurality of X electrodes of the first and second row groups G₁ and G₂. Then, a write discharge may be is generated in a discharge cell to which the scan pulse of the VscL1 voltage and the address pulse of the positive voltage are applied. Thus, a wall voltage is formed in the X and Y electrodes, so that the discharge cells are switched to a light emitting cell. A voltage VscH1 that is higher than the voltage VscL1 may be applied to Y electrodes to which the scan pulse is not applied, and the reference voltage may be applied to A electrodes to which the address pulse is not applied.

In further detail, the scan pulse may be applied to a Y electrode Y₁ of the first row of the first row group G₁, and, at the same time, the address pulse may be applied to an A electrode of a light emitting cell of the first row. Then, a write discharge may be generated between the Y electrode of the first row and the A electrode applied with the address pulse, so that positive (+) wall charges are formed on the Y electrode and negative (−) wall charges are formed on the A and X electrodes. Subsequently, the scan pulse may be applied to a Y electrode Y₂ of the second row and, at the same time, the address pulse may be applied to an A electrode of a light emitting cell of the second row. Then, a write discharge is generated between the A electrode applied with the address pulse and the Y electrode of the second row so that wall charges are formed on the respective electrodes Y, A, and X. In a like manner, the wall charges may be formed on the respective Y, A, and X electrodes by applying the address pulse to the A electrode of a light emitting cell while sequentially applying the scan pulse to the remaining Y electrodes.

During the sustain period S1₁, the voltage Vs may be applied to the plurality of Y electrodes of the first and second row groups G₁ and G₂, and the reference voltage may be applied to the plurality of X electrodes of the first and second row groups G₁ and G₂, so as to sustain discharge the light emitting cells. Since a cell that has experienced the write discharge during the address period WA1₁ may be switched to a light emitting cell, only a cell that has experienced the write discharge during the address period WA1₁ experiences the sustain discharge. As a result of the sustain discharge, negative (−) wall charges are formed on the Y electrodes and positive (+) wall charges are formed on the X electrodes of the first row group G₁. In FIG. 5A, the sustain discharge is generated once during the sustain period S1₁.

In the address period WA1₂, the scan pulse of the voltage VscL may be sequentially applied to the Y electrodes of the second row group G₂ and the address pulse of the positive voltage may be applied to the A electrode, so as to write discharge cells in the non-light emitting state for selecting light emitting cells, while the voltage Vs is applied to the plurality of X electrodes of the first and second row groups G₁ and G₂, and the voltage VscH is applied to the Y electrodes of the first row group G₁. Since the voltage VscH1 is low, a sustain discharge is generated in the light emitting cells of the first row group G₁ by the voltage Vs applied to the X electrodes of the first row group G₁ and the wall charges formed on the Y and X electrodes of the first row group G₁. As a result of the sustain discharge, positive (+) wall charges are formed on the Y electrodes of the first row group G₁ and negative (−) wall charges are formed on the X electrodes of the first row group G₁.

Subsequently, in a first period S1₂₁ of the sustain period S1₂, the voltage Vs may be applied to the plurality of Y electrodes of the first and second row groups G₁ and G₂, and the reference voltage may be applied to the plurality of X electrodes of the first and second row groups G₁ and G₂ to sustain discharge the light emitting cells of the first and second row groups G₁ and G₂. In a second period S1₂₂ of the sustain period S1₂, the voltage Vs may be applied to the plurality of Y electrodes of the first row group G₁ and the reference voltage may be applied to the plurality of Y electrodes of the second row group G₂, while the voltage Vs is applied to the plurality of X electrodes of the first and second row groups G₁ and G₂, so as to sustain discharge only the light emitting cells of the second row group G₂. Then, in the second period S1₂₂, the voltage Vs may be applied to the plurality of Y electrodes of the second row group G₂ and the reference voltage may be applied to the plurality of X electrodes of the second row group G₂, so as to additionally sustain discharge the light emitting cells of the second row group G₂. Since the light emitting cells of the first row group G₁ have not experienced the sustain discharge in the first period S1₂₁, they do not experience the sustain discharge in the second period S1₂₂. The number of sustain discharges generated in the light emitting cells of the second row group G₂ during the second period S1₂₂ may correspond to the number of sustain discharges generated in the light emitting cells of the first row group G₁ during the periods S1₁ and WA1₂. In addition, when a weight of the first subfield SF1 is not satisfied by the sustain periods S1₁ and S1₂, an additional sustain period may be applied to simultaneously sustain discharge the light emitting cells of the first and second row groups G₁ and G₂.

FIG. 5B shows a driving waveform of the k-th subfield SFk among the second to L-th subfields SF2 to SFL of FIG. 3. For better understanding and ease of description, FIG. 5B illustrates first and second sub-groups G₁₁ and G₁₂ of the first row group G₁ and fifth and sixth sub-groups G₂₅ and G₂₆ of the second row group G₂ of one subfield SFk among the second to L-th subfields SF2 to SFL.

As shown in FIG. 5B, in an address period EAk₁₁ of the first sub-group G₁₁ of the first row group G₁, a scan pulse having a voltage VscL2 may be applied to a plurality of Y electrodes of the first sub-group G₁₁, and the reference voltage (0V voltage in FIG. 5B) may be applied to an X electrode of the first row group G₁. In this case, an address pulse (not shown) having a positive voltage may be applied to an A electrode of a cell to be selected as a non-light emitting cell among light emitting cells formed by the Y electrodes to which the scan pulse is applied. In addition, voltage VscH2 that is higher than the voltage VScL2 may be applied to a Y electrode to which the scan pulse is not applied among the Y electrodes of the first row group G₁ and a plurality of Y electrodes of the second row group G₂, and the reference voltage may be applied to an A electrode to which the address pulse is not applied. Then, an erase discharge is generated in a light emitting cell to which the scan pulse of the voltage VscL2 and the address pulse of the positive voltage are applied. Thus, the light emitting cell may be switched to a non-light emitting cell.

Although FIG. 5B illustrates that the scan pulse is applied to one Y electrode during the address period EAk₁₁ for better understanding and ease of description, the scan electrode driver 400 may sequentially select Y electrodes to be applied with the scan pulse among the plurality of Y electrodes of the first sub-group G₁₁. For example, vertically arranged Y electrodes may be sequentially selected in a single driving mode. When one of the Y electrodes is selected, the address electrode driver 300 may select turn-on discharge cells among discharge cells formed by the selected Y electrode. That is, the address electrode driver 300 may select a discharge cell to which an address pulse having the voltage Va among the A electrodes A1 to Am is applied.

In a sustain period Sk₁₁ of the first sub-group G₁₁, a sustain discharge pulse alternately having a high level voltage (voltage Vs in FIG. 5B) and a low level voltage (0V voltage in FIG. 5B) may be applied to the plurality of X electrodes and a plurality of Y electrodes of the first row group G₁, so as to sustain discharge the light emitting cells of the first sub-group G₁₁. Herein, the sustain discharge pulse applied to the X electrodes has a reverse phase of the sustain discharge pulse applied to the Y electrodes. That is, when the high level voltage is applied to the X electrodes, the low level voltage is applied to the Y electrodes, and when the high level voltage is applied to the Y electrodes, the low level voltage is applied to the X electrodes. Discharge cells that have not experienced an erase discharge during the address period EAk₁₁ among discharge cells in the light emitting state in the previous subfield SF(k−1) remain in the light emitting state and experience a sustain discharge.

An address period EAk₂₆ of the sixth sub-group G₂₆ may be performed while the sustain period Sk₁₁ of the first sub-group G₁₁ is performed. In the address period EAk₂₆, the scan pulse having the voltage VscL2 may be applied to a plurality of Y electrodes of the second sub-group G₁₂ while the reference voltage is applied to an X electrode of the second row group G₂, and an address pulse (not shown) having a positive voltage may be applied to an A electrode of a discharge cell to be selected as a non-light emitting cell among light emitting cells formed by the Y electrodes to which the scan pulse is applied. The voltage VscH2 may be applied to Y electrodes to which the scan pulse is not applied among the Y electrodes of the second row group G₂ and the Y electrodes of the first row group G₁, and the reference voltage may be applied to A electrodes to which the address pulse is not applied. Then, an erase discharge is generated in the light emitting cell to which the scan pulse having the voltage VscL2 and the address pulse having the positive voltage may be applied, so that the wall charges formed on the X and Y electrodes are erased, and the light emitting cell is switched to a non-light emitting cell.

Subsequently, a sustain period Sk₂₆ of the sixth sub-group G₂₆ of the second row group G₂ may be performed. In the sustain period Sk₂₆, a sustain pulse is applied to the plurality of X and Y electrodes of the second row group G₂ and thus, a sustain discharge is generated in the corresponding light emitting cells. Herein, the sustain pulse applied to the X electrodes has an opposite phase to that of the sustain pulse applied to the Y electrodes.

The address period EAk₁₂ of the second sub-group G₁₂ of the first row group G₁ is performed while the sustain period Sk₂₆ is performed. In the address period EAk₁₂, the scan pulse having the voltage VscL2 may be applied to the Y electrodes of the second sub-group G₁₂ and the reference voltage may be applied to the X electrode of the first row group G₁. The address pulse having the voltage Va may be applied to an A electrode of a light emitting cell to be switched to the non-light emitting state among light emitting cells formed by the Y electrodes to which the scan pulse having the voltage VscL2 is applied. In addition, Y electrodes of the first row group G₁, to which no sustain pulse has been applied, may be applied with the voltage VscH2, and the reference voltage may be applied to A electrodes to which the address pulse is not applied. Then, an erase discharge is generated in the light emitting cell to which the scan pulse having the VscL2 and the address pulse having the voltage Va are applied. Thus, the wall charges formed on the X and Y electrodes are erased and the light emitting cells are switched to the non-light emitting state.

Address periods EAk₁₃ to EAk₁₆ and sustain periods Sk₁₂ to Sk₁₆ of the other sub-groups G₁₂ to G₁₆ of the first row group G₁, and address periods EAk₂₅ to EAk₂₁ and sustain periods Sk₂₅ to Sk₂₁ of the other sub-groups G₂₅ to G₂₁ of the second row group G₂ may be performed in a like manner.

Accordingly, the sustain period may be applied to the row electrodes of the second row group G₂ while the address period is applied to the row electrodes of the first row group G₁, and the sustain period may be applied to the row electrodes of the first row group G₁ while the address period is applied to the row electrodes of the second row group G₂. In other words, the sustain period may be performed while the address period is performed, rather than dividing the address period and the sustain period. Accordingly, the length of one subfield may be reduced. In addition, since the address period is provided between the respective sustain periods of each sub-group, priming particles formed during the sustain periods may be effectively utilized during the address period. Accordingly, a high-speed scanning process with a short scan pulse may be performed. Therefore, the number of subfields that may be used for one frame is increased, thereby increasing the maximum grayscale level that can be expressed.

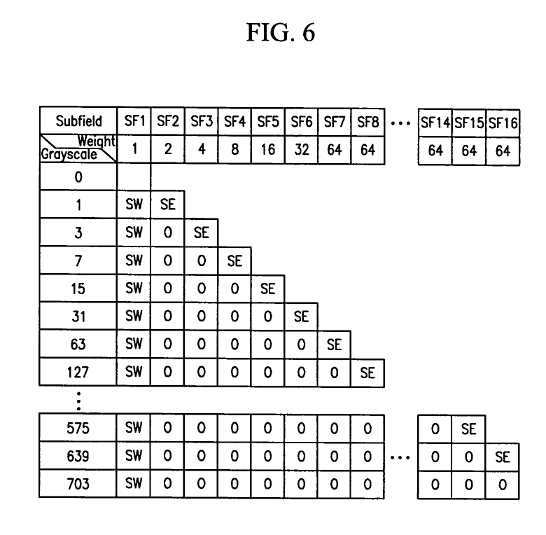

A method for expressing a grayscale by using the driving method of FIG. 3 will be described in further detail with reference to FIG. 6.

FIG. 6 illustrates a grayscale expression method according to a first exemplary embodiment of the present invention. In FIG. 6, one field includes sixteen subfields. When a write discharge is generated in the corresponding subfield and thus, a non-light emitting cell is switched to the light emitting state, that subfield is denoted by “SW”. When an erase discharge is generated in the corresponding subfield and thus, a light emitting cell is switched to the non-light emitting state, that subfield is denoted by “SE”. When a discharge cell is in the light emitting state, that subfield is denoted by “∘”.

As shown in FIG. 6, weights of the first to sixteenth subfields SF1 to SF16 may be respectively set to 1, 2, 4, 8, 16, 32, 32, 64, . . . , and 64. That is, the weights of the first to sixth subfields SF1 to SF6 may be respectively set to 1, 2, 4, 8, 16, and 32, and the weights of the seventh to sixteenth subfields SF7 to SF16 may all be set to 64. When no write discharge is generated during an address period of the first subfield SF1 among the subfields SF1 to SF16 having such weights, no sustain discharge is generated in the first subfield SF1 and the next subfields SF2 to SF16. Accordingly, a grayscale of 0 is expressed. When the write discharge is generated in the address period of the first subfield SF1 and thus, a discharge cell of the first subfield is switched to the light emitting state, a sustain discharge is generated in the second subfield SF2. Accordingly a grayscale of 1 may be expressed. When an erase discharge is generated in an address period of the second subfield SF2 and thus, a discharge cell of the second subfield SF2 is switched to the non-light emitting state, no sustain discharge is generated from the second subfield SF2 to the sixteenth subfield SF16. Accordingly, the grayscale of 1 may be expressed. In addition, when the erase discharge is not generated in the address period of the second subfield SF2, but is generated in an address period of the third subfield SF3, the light emitting cell is switched to the non-light emitting state. Accordingly, a grayscale of 3 may be expressed.

In general, when an erase discharge is generated in the k-th subfield and thus the light emitting cell is switched to the non-light emitting state, a discharge cell in the light emitting state continuously experiences a sustain discharge from the first to (k−1)-th subfields. Accordingly, a grayscale that corresponds to a sum of weights of the first to (k−1)-th subfields may be expressed. A grayscale that cannot be expressed by a sum of the weights of the respective subfields may be expressed by using dithering. Such dithering is a technology for approximately and on average expressing the grayscale to be expressed in a predetermined area by combining predetermined grayscales. For example, grayscales between a grayscale of 31 and a grayscale of 63 can be expressed by dithering the grayscales 31 and 63 in a predetermined pixel area.

As described, the grayscales may be expressed by the consecutive subfields SF2 to SF16 until discharge cells in the light emitting state are erase-discharged in the corresponding subfield, i.e., they are switched to the non-light emitting state. Therefore, occurrence of contour noise may be reduced or eliminated according to the first exemplary embodiment of the present invention. In addition, the discharge cells that are switched to the light emitting state in the first subfield SF1 may be continuously sustain discharged until they are erase-discharged, i.e., switched to the non-light emitting state. Therefore, any grayscale may be expressed by performing a sustain discharge twice at most. Accordingly, power consumption can be reduced.

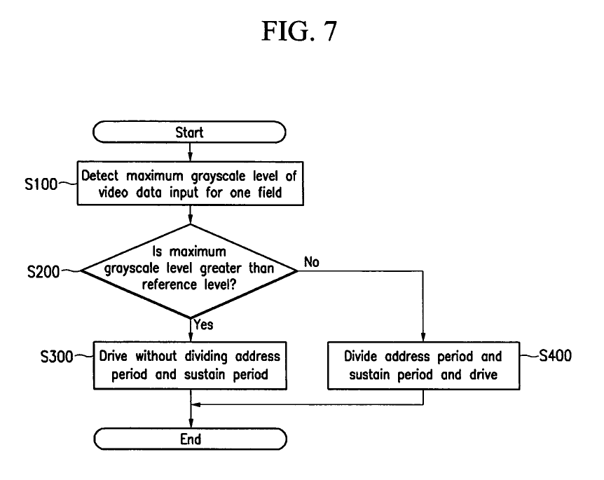

However, since the human eye recognizes a grayscale difference better between low grayscales than between high grayscales, expression of low grayscales may be degraded when the low grayscales are expressed by using the dithering method rather than using a combination of grayscales of subfields. Hereinafter, an exemplary embodiment for increasing the maximum grayscale level while improving expression of low grayscales will be described in further detail with reference to FIG. 7.

FIG. 7 illustrates a flowchart of the controller 200 according to an exemplary embodiment of the present invention.

As shown in FIG. 7, the controller 200 may detect the maximum grayscale level of video signals input during one field in operation S100, and may compare the detected maximum grayscale level with a reference level in operation S200. When the detected maximum grayscale level is higher than the reference level, the controller 200 may output control signals to the respective drivers 300, 400, and 500 for driving the plasma display without dividing an address period and a sustain period, e.g., using the driving method shown in FIG. 3, in operation S300. When the detected maximum grayscale level is less than the reference level, the controller 200 may output control signals to the respective drivers 300, 400, and 500 for driving the plasma display by dividing the address period and the sustain period, in operation S400. For example, the reference level may be set to about ⅔ of the maximum grayscale level that can be expressed by the driving method of FIG. 3. When the maximum grayscale level equals the reference level, the controller 200 may use either driving method noted above. For example, in an implementation, when the maximum grayscale level is equal to the reference level, the plasma display may be driven by dividing the address period and the sustain period. Alternatively, when the maximum grayscale level is equal to the reference level, the plasma display may be driven without dividing the address period and the sustain period.

For example, when the number of row electrodes is 768 and a total number of sustain pulses in one frame is 1200, the reset period may be 0.5 ms, one scan pulse may be applied in 1.1 μs, and one sustain pulse may be applied in 0.6 μs. Since one frame time is 16.67 ms (= 1/60 sec), approximately 10(=(16.67 ms−0.5 ms−(6.0 μs×1200))/(1.1 μs×768)) subfields may be used during one frame when the plasma display is driven by dividing the address period and the sustain period. When the plasma display is driven without dividing the address period and the sustain period, the length of one subfield becomes 936 μs (=156×6), assuming that one group time is 156 μs. Therefore, approximately 17(=(16.67 ms−(1.1 μs×768×1+6.0 μs))/936 μs) subfields may be used during one frame. However, since one subfield is required for performing a sustain discharge to the last sub-group, approximately 16 subfields may be substantially used during one frame.

When the number of row electrodes increases (e.g., the number of row electrodes is 1080), the address period increases when the address period and the sustain period are divided. Therefore, time allocated to each sustain period is reduced. For example, the time allocated to the address period becomes 11.9 ms (=1.1 μs×1080×10) in one frame. Therefore, a sustain discharge may be performed approximately 700 times for one frame. However, when the plasma display is driven without dividing the address period and the sustain period, the sustain discharge can be performed 1200 times for one frame. Thus, for this particular example, the maximum grayscale level that may be realized using the driving method for driving the plasma display in which the address period and the sustain period are divided is about ⅔ of the maximum grayscale level that may be realized using the driving method for driving the plasma display in which the address period and the sustain period are not divided.

When the maximum grayscale level to be expressed within one frame is less than a reference level, e.g., ⅔ of the maximum grayscale level that may be expressed by using the driving method in which the address period and the sustain period are not divided, e.g., as shown in FIG. 3, the controller 200 may use the driving method that divides the address period and the sustain period, to thereby improve grayscale expression ability and prevent excessive electromagnetic interference. When the maximum grayscale level to be expressed within one frame is greater than the reference level, e.g., ⅔ of the maximum grayscale level that can be expressed by using the driving method in which the address period and the sustain period are not divided, the controller 200 may use the driving method for driving the plasma display without dividing the address period and the sustain period.

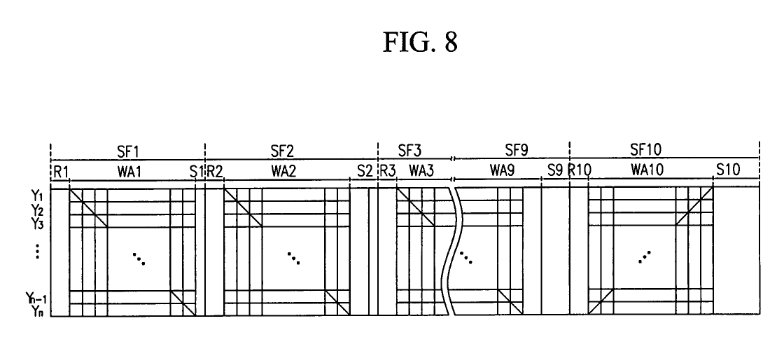

The driving method that divides the address period and the sustain period in a temporal manner will now be described in further detail with reference to FIG. 8 to FIG. 10.

FIG. 8 illustrates a diagram representing a driving method for driving the plasma display by dividing the address period and the sustain period according to the exemplary embodiment of the present invention.

As shown in FIG. 8, in the plurality of subfields SF1 to SF10 of one field, a selective write method for selecting the light emitting cell and the non-light emitting cell may be used. In further detail, the subfields SF1 to SF10 may respectively include reset periods R1 to R10, address periods WA1 to WA10, and sustain periods S1 to S10. The discharge cells may be initialized in the respective reset periods R1 to R10 to be established in a non-light emitting cell state. Discharge cells to be established in a light emitting cell state from the non-light emitting cell state may be write-discharged to form wall charges in the respective address periods WA1 to WA10. Finally, the light emitting cells selected in the corresponding address periods WA1 to WA10 may be sustain discharged in the sustain periods S1 to S10.

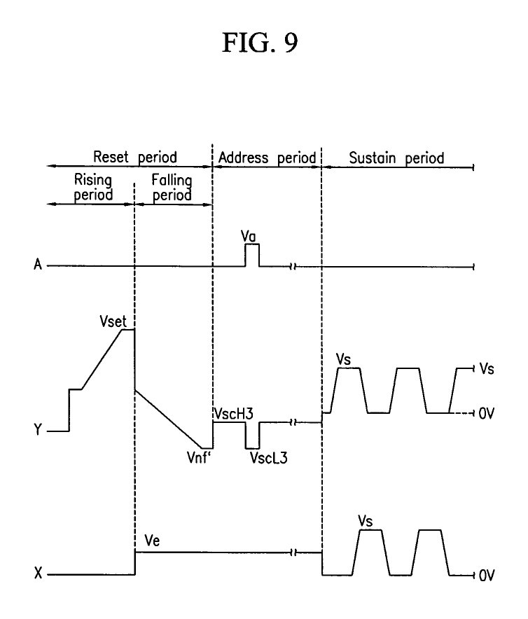

FIG. 9 illustrates a diagram representing driving waveforms of the plasma display driven in the driving method shown in FIG. 8. In FIG. 9, for better understanding and ease of description, one subfield among the plurality of subfields is illustrated, and one X electrode, one Y electrode, and one A electrode are illustrated.

As shown in FIG. 9, during a rising period of the reset period, while the X electrode is maintained at the reference voltage (the 0V voltage in FIG. 9), the voltage of the Y electrode may gradually increase, e.g., in a ramp waveform, from the Vs voltage to the Vset voltage. Thereby, a weak discharge may be generated between the Y and X electrodes, and between the Y and A electrodes while the voltage of the Y electrode increases. Thus, (−) wall charges are formed on the Y electrode, and (+) wall charges are formed on the X and A electrodes.

During a falling period of the reset period, while the X electrode is maintained at a Ve voltage, the voltage of the Y electrode may gradually decrease, e.g., in a ramp waveform, from the Vs voltage to a Vnf voltage. Thereby, a weak discharge may be generated between the Y and X electrodes and the Y, and A electrodes while the voltage of the Y electrode decreases. Thus, the (−) wall charges formed on the Y electrode and the (+) wall charges formed on the X and A electrodes are eliminated. In general, a voltage of (Vnf−Ve) may be close to a discharge firing voltage between the Y electrode and the X electrode. Thereby, a wall voltage between the Y and X electrodes approaches the 0V voltage, and the cell having no address discharge during the address period does not misfire during the sustain period.

During the address period, while the voltage of the X electrode is maintained at the Ve voltage, a scan pulse having a VscL3 voltage and an address pulse having the Va voltage may be respectively applied to the Y electrode and the A electrode to select the light emitting cell. A VscH3 voltage that is higher than the VscL3 voltage is applied to the Y electrode to which the VscL3 voltage is not applied, and the reference voltage is applied to the A electrode of the non-light emitting cell. A value of |VscL3−VscH3| may be the same as a value of |VscL1−VscH1| in FIG. 5A, and a value of |VscL3−Ve| may be the same as a value of |VscL1−Vs| in FIG. 5A.

During the sustain period, the sustain pulse alternately having the Vs voltage and the reference voltage is applied to the Y electrode and the X electrode. The sustain pulse applied to the Y electrode may have an opposite phase of the sustain pulse applied to the X electrode. In other words, the reference voltage is applied to the X electrode when the Vs voltage is applied to the Y electrode, and the reference voltage is applied to the Y electrode when the Vs voltage is applied to the X electrode. Subsequently, an operation for applying the sustain pulse of the Vs voltage to the Y electrode and an operation for applying the sustain pulse of the Vs voltage to the X electrode are repeatedly performed a number of times corresponding to a weight value of the corresponding subfield.

In addition, the respective subfields SF1 to SF10 may use the driving waveform shown in FIG. 5A, or may use other driving waveforms in accordance with the selective write method.

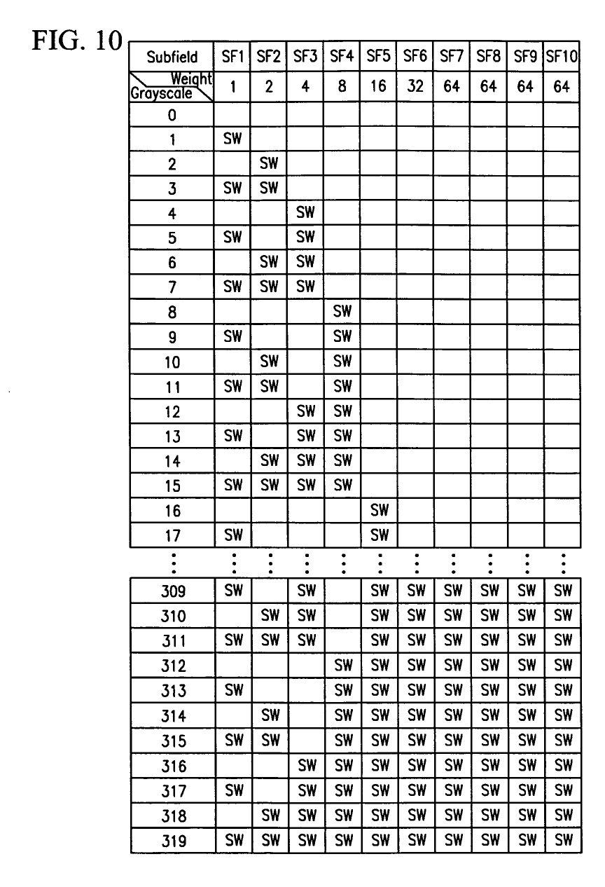

FIG. 10 illustrates a diagram representing a grayscale expression method in the driving method shown in FIG. 8.

As shown in FIG. 10, 0 to 319 grayscales may be continuously expressed by combinations of turned-on subfields among the plurality of subfields SF1 to SF10. Since the respective subfields SF1 to SF10 include reset periods R1 to R10 for establishing all the discharge cells to be in the non-light emitting cell state, the cell of the light emitting cell state in a previous subfield may be established to be in the non-light emitting cell state. Accordingly, since grayscales may be expressed by combinations of the turned-on subfields among the plurality of subfields SF1 to SF10, performance of expressing low grayscales may be improved compared to the driving method shown in FIG. 3.

As described above, according to the exemplary embodiment of the present invention, since different driving methods are respectively applied according to the maximum grayscale level of the video signal input for one field, the performance of expressing low grayscales may be improved, while still allowing higher grayscales to be expressed.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A driving method of a plasma display including a plurality of row electrodes, a plurality of column electrodes, and a plurality of discharge cells respectively defined by the plurality of row electrodes and the plurality of column electrodes, the driving method for driving the plasma display including dividing a field into a plurality of subfields, the driving method comprising:
determining a maximum grayscale level of a video signal input for the field;
comparing the maximum grayscale level of the video signal to a reference level; and
driving the plasma display in accordance with the comparing, wherein,
when the maximum grayscale level of the video signal is greater than the reference level, driving a plurality of subsequent subfields after a first subfield of the plurality of subfields includes:
dividing the plurality of row electrodes into first and second row electrode groups, and
sustain-discharging light emitting cells in a second subgroup of the second row electrode group while selecting non-light emitting cells from a plurality of light emitting cells in a first subgroup of the first row electrode group; and
when the maximum grayscale level of the video signal is less than the reference level, driving the plurality of subfields includes, for each of the plurality of subfields:
selecting light emitting cells from the plurality of discharge cells, and
sustain discharging the selected light emitting cells.

2. The driving method as claimed in claim 1, further comprising, when the maximum grayscale level of the video signal is greater than the reference level, sustain discharging light emitting cells in a subgroup of the first row electrode group while selecting non-light emitting cells from the light emitting cells in a subgroup of the second row electrode group.

3. The driving method as claimed in claim 2, further comprising, when the maximum grayscale level of the video signal is less than or equal to the reference level, establishing the plurality of discharge cells as non-light emitting cells before selecting light emitting cells.

4. The driving method as claimed in claim 1, further comprising, when the maximum grayscale level of the video signal is greater than the reference level, in a first subfield before the plurality of subsequent subfields:
selecting light emitting cells from discharge cells in the first row electrode group, and sustain-discharging the selected light emitting cells of the first row electrode group; and
selecting light emitting cells from the discharge cells in the second row electrode group, and sustain-discharging the selected light emitting cells of the second row electrode group.

5. The driving method as claimed in claim 4, further comprising, in the first subfield, establishing the plurality of discharge cells as the non-light emitting cells before selecting the light emitting cell from the discharge cells included in the first row electrode group.

6. The driving method as claimed in claim 1, wherein a number of subfields that may be realized when using the driving corresponding to when the maximum grayscale level of the video signal is greater than the reference level is larger than a number of subfields that may be realized when using the driving corresponding to when the maximum grayscale level of the video signal is less than or equal to the reference level.

7. The driving method as claimed in claim 1, wherein the reference level is about ⅔ of a maximum grayscale level that may be expressed when using the driving corresponding to when the maximum grayscale level of the video signal is greater than the reference level.

8. The driving method as claimed in claim 1, further comprising, when the maximum grayscale level of the video signal is greater than the reference level, and a desired grayscale level cannot be expressed from a combination of subfields, dithering subfields having levels closest to the desired grayscale level.

9. A plasma display, comprising:
a plasma display panel (PDP) including a plurality of row electrodes, a plurality of column electrodes crossing the plurality of row electrodes, a plurality of discharge cells defined by the plurality of row electrodes and the plurality of column electrodes;
a driver configured to drive the PDP; and
a controller configured to determine a maximum grayscale level from a video signal input for one field, to compare the maximum grayscale level of the video signal to a reference level, and to control the driver in accordance with the comparison, wherein:
when the maximum grayscale level of the video signal is greater than the reference level, for a plurality of subsequent subfields after a first subfield of the field, the driver is configured to simultaneously:
select one of light emitting cells and non-light emitting cells from the plurality of discharge cells, and
sustain discharge cells among previous light emitting cells; and
when the maximum grayscale level of the video signal is less than the reference level, the driver is configured to, for each of the subfields:
select light emitting cells from the plurality of discharge cells, and sustain discharge the selected light emitting cells.

10. The plasma display as claimed in claim 9, further comprising, when the maximum grayscale level of the video signal is greater than the reference level, the driver is configured to select light emitting cells in the first subfield and non-light emitting cells in the plurality of subsequent subfields.

11. The plasma display as claimed in claim 10, wherein the driver is configured to establish the plurality of discharge cells as non-light emitting cells before selecting light emitting cells in a subsequent field.

12. The plasma display as claimed in claim 9, wherein, when the maximum grayscale level of the video signal is greater than the reference level, the driver is configured, for the plurality of subsequent subfields, to:
divide the plurality of row electrodes into first and second row electrode groups;
divide the first and second row electrode groups into a plurality of first and second subgroups;
sustain discharge light emitting cells of a subgroup among the plurality of second subgroups and simultaneously select non-light emitting cells from light emitting cells of a subgroup among the plurality of first subgroups; and
sustain discharge light emitting cells of a first subgroup among the plurality of first subgroups and simultaneously select non-light emitting cells from light emitting cells of a subgroup of the second subgroups.

13. The plasma display as claimed in claim 12, wherein, when the maximum grayscale level of the video signal is greater than the reference level, the driver is configured, for at least one subfield before the plurality of subsequent subfields, to:
select light emitting cells from the discharge cells of the first row electrode group and sustain discharge the selected light emitting cells of the first row electrode group; and
select light emitting cells from the discharge cells of the second row electrode group, and sustain discharge the selected light emitting cell of the second row electrode group.

14. A plasma display, comprising:
a plasma display panel (PDP) including a plurality of row electrodes, a plurality of column electrodes crossing the plurality of row electrodes, and a plurality of discharge cells defined by the plurality of row electrodes and the plurality of column electrodes;
a driver configured to drive the PDP; and
a controller configured to determine a maximum grayscale level from a video signal input for one field, to compare the maximum grayscale level from the video signal to a reference level, and to control the driver in accordance with a result of the comparison, wherein:
when the maximum grayscale level is greater than the reference level, the driver is configured, in a first subfield, to:
divide the plurality of row electrodes into first and second row electrode groups,
divide the first and second row electrode groups into a plurality of first and second subgroups,
sequentially address discharge row electrodes in a first subgroup using a first address discharge method to establish light emitting cells in the first subgroup during a first period for respective first subgroups,
sustain discharge previously established light emitting cells in second subgroups during a plurality of first periods,
sequentially address discharge row electrodes in a second subgroup using the first address discharge method to establish light emitting cells in the second subgroup during a second period for respective second subgroups, and
sustain discharge previously established light emitting cells in first subgroups during a plurality of second periods, and
when the maximum grayscale level is less than the reference level, the driver is configured, in each of the plurality of subfields, to:
sequentially address discharge the plurality of row electrodes using a second address discharge method to establish light emitting cells during a third period, and
sustain discharge the established light emitting cells during a fourth period.

15. The plasma display as claimed in claim 14, wherein discharge cells in a light emitting state are established to be in a non-light emitting state by the first address discharge method, and discharge cells in the non-light emitting state are established to be in the light emitting discharge state by the second address discharge method.

16. The plasma display as claimed in claim 15, wherein the driver is configured to establish the plurality of discharge cells as light emitting cells immediately before the earliest first period among the plurality of first periods when using the first address discharge method, and to establish the plurality of discharge cells as non-light emitting cells in each of the subfields before selecting the light emitting cells when using the second address discharge method.

17. The plasma display as claimed in claim 15, wherein the plurality of row electrodes is defined by respective pluralities of first and second electrodes, and the driver is configured to:
during the first period for the respective first subgroups, sequentially apply a scan pulse of a first level to the plurality of first electrodes included in the corresponding subgroup and apply an address pulse to the column electrode defining non-light emitting cells among light emitting cells defined by the first electrode included in the first subgroup to which the scan pulse is applied; and
during the third period, sequentially apply the scan pulse of a second level to the plurality of first electrodes, and apply the address pulse to the column electrode defining light emitting cells among non-light emitting cells defined by the plurality of first electrodes to which the scan pulse of the second level is applied.

18. The plasma display as claimed in claim 15, wherein the plurality of respective row electrodes is defined by a respective plurality of first and second electrodes, and the driver is configured to apply first and second sustain pulses having inverse phases to the first and second electrodes included in at least one second subgroup among the plurality of second subgroups during the first period for the respective first subgroups, and respectively apply the first and second sustain pulses to the plurality of first electrodes and the plurality of second electrodes during the fourth period, and
the first and second sustain pulses respectively have a high level voltage and a low level voltage.

19. The plasma display as claimed in claim 15, wherein one second period among the plurality of second periods is positioned between the respective first periods among the plurality of first periods.

20. A controller configured to control a driver configured to drive a plasma display panel (PDP) including a plurality of row electrodes, a plurality of column electrodes crossing the plurality of row electrodes, and a plurality of discharge cells defined by the plurality of row electrodes and the plurality of column electrodes, the controller being configured to:
determine a maximum grayscale level of a video signal input for a field divided into a plurality of subfields;
compare the maximum grayscale level of the video signal to a reference level; and
control the driver of the PDP in accordance with the comparing, wherein:
when the maximum grayscale level of the video signal is greater than the reference level, for a plurality of subsequent subfields after a first subfield of the field, the driver is configured to:
divide the plurality of row electrodes into first and second row electrode groups, and
sustain discharge light emitting cells in a subgroup of the second row electrode group and simultaneously address discharge row electrodes in a subgroup of the first row electrode group to establish light emitting cells; and
when the maximum grayscale level of the video signal is less than the reference level, for the plurality of subfields, the driver is configured to:
select light emitting cells from the plurality of discharge cells, and sustain discharge the selected light emitting cells.
